(19) United States
(12) Patent Application Publication
(10) Pub. No.: US 2026/0363278 A1
(43) Pub. Date: Nov. 19, 2026

(54) LIQUID FOODSTUFF COMPRISING BETA-GLUCAN; HYDROLYSATE FROM AN OAT-BASED MATERIAL; AND RELATED METHODS

(71) Applicant: SOCIÉTÉ DES PRODUITS NESTLÉ S.A., Vevey (CH)

(72) Inventors: Denise TAN, Singapore (SG); Kim-Anne LE BUR, Lausanne (CH); Ching Theng TAN, Johor Bahru (MY); Wen WANG, Singapore (SG); Youyun LIANG, Singapore (SG)

(21) Appl. No.: 19/121,963

(22) PCT Filed: Oct. 20, 2023
(86) PCT No.: PCT/EP2023/079318

§ 371 Date: Apr. 17, 2025

(30) Foreign Application Priority Data
Oct. 21, 2022 (EP) 22203101.5

(51) Int. Cl. A23L 2/52; A23L 7/104; A23L 23/00

(52) U.S. Cl. CPC A23L 2/52; A23L 7/107; A23L 23/00

(57) ABSTRACT

A liquid foodstuff containing β-glucan having an average molecular weight between 400 kDa and 5000 kDa, preferably between 500 kDa and 3000 kDa, and the liquid foodstuff having a shear viscosity between 0.0001 Pa·s (pascal second) and 0.3 Pa·s, preferably between 0.001 Pa·s and 0.2 Pa·s, when measured at 25 °C at a shear rate of 0.1 s⁻¹, 1 s⁻¹, 10 s⁻¹ and 100 s⁻¹. The liquid foodstuff preferably has a β-glucan content that is one or more of: at least 0.5 g of the β-glucan per serving; or between 0.1 g and 1 g of the β-glucan per 100 ml of the liquid foodstuff, preferably at least 0.75 g per serving of the liquid foodstuff; or between 0.35 g and 1.5 g of the β-glucan per 100 ml of the liquid foodstuff.

### BACKGROUND

Existing enzyme solutions applied to oat have only been able to achieve one of the two target goals, i.e., sensory improvement or alternatively maintenance of β-glucan MW and its associated health properties. Unhydrolyzed oat bran presents poor solubility and high viscosity, thus limiting its application in beverage applications when physiologically relevant dosages of beta-glucan are incorporated.

The “carbohydrate metrics” described as variations of carbohydrates: fibre: free sugar ratios with at least 1 g of dietary fibre for every 10 g of total carbohydrates, has been found to be associated with a better overall nutritional composition (Nutrients, 12(9). doi:10.3390/nu12092771, 2020). However, not all fibres are equally beneficial. Fibres known to attenuate glycemic response are typically viscous and significantly negatively impact the texture and thus palatability of a beverage (e.g., TP-PC in the current clinical study). Occasionally, the ratio can be achieved by using various soluble fibres (e.g., corn soluble fibre), but this does not deliver on the expected health benefit of lowering glucose response at the same dose. Today there is a need for a technical solution that allows the “carbohydrate metrics” to lower glucose response in a beverage, whilst maintaining high sensory properties.

### SUMMARY

The present disclosure generally relates to a liquid foodstuff comprising-glucan having an average molecular weight between 400 kDa and 5000 kDa, and further relates to hydrolysates (comprising such β-glucan) from oat-based materials, and methods of making and using such liquid foodstuffs. Specifically, the present disclosure relates to a liquid foodstuff comprising β-glucan having an average molecular weight between 400 kDa and 5000 kDa, preferably from enzymatic hydrolysis of oat-based materials (e.g., oat bran), for an improvement in sensory properties in a liquid application, whilst maintaining β-glucan molecular weight (MW) and health properties. For example, it was found that an enzyme cocktail employed at specific hydrolysis conditions for the controlled hydrolysis of oat-based materials (e.g., oat bran) to maximize breakdown of starches but minimize hydrolysis of β-glucans. This allows the improvement of product texture and taste, whilst maintaining its β-glucan MW and health properties.

The present disclosure includes the recognition that a liquid foodstuff comprising β-glucan having an average molecular weight between 400 kDa and 5000 kDa not only improves sensory properties of the liquid foodstuff, but also maintains its β-glucan MW and health properties. Indeed, the liquid foodstuff comprising β-glucan having an average molecular weight between 400 kDa and 5000 kDa can be used as a food or supplement to a subject to both improve sensory properties of the liquid foodstuff and maintain the β-glucan MW and health properties.

### BRIEF DESCRIPTION OF DRAWINGS

FIG. 1 is a table showing the results of nutritional compositions of ingredients alone before supplementation into a powdered cocoa malt beverage according to certain embodiments of the present invention.

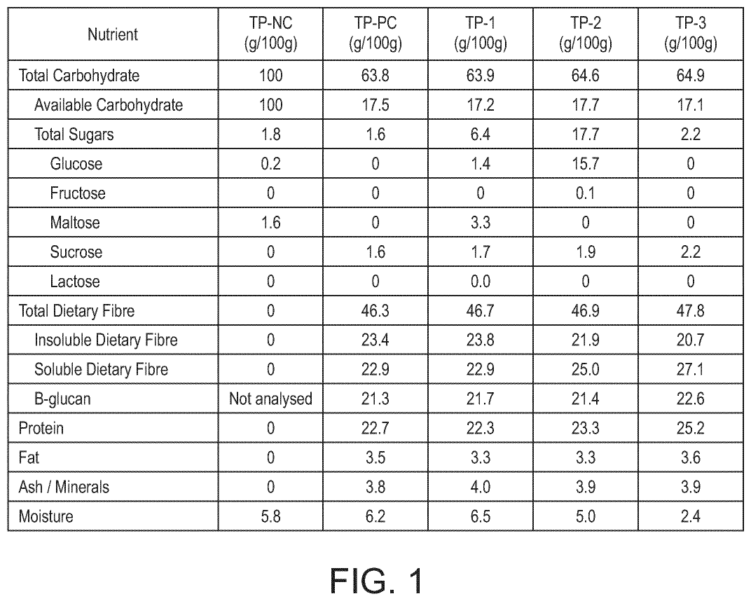

FIG. 2 is a table showing the results of nutritional compositions of Cocoa Malt Beverage (CMB) powder samples according to certain embodiments of the present invention. TP-NC: powdered cocoa malt beverage with readily-digestible Carbohydrates; TP-PC: powdered cocoa malt beverage with minimally-processed oat; TP-1: powdered cocoa malt beverage with oat hydrolysed with a protease and an α-amylase; TP-2: powdered cocoa malt beverage with oat hydrolysed with a protease, an α-amylase and an amyloglucosidase; and TP-3: powdered cocoa malt beverage ® with Extruded Oat.

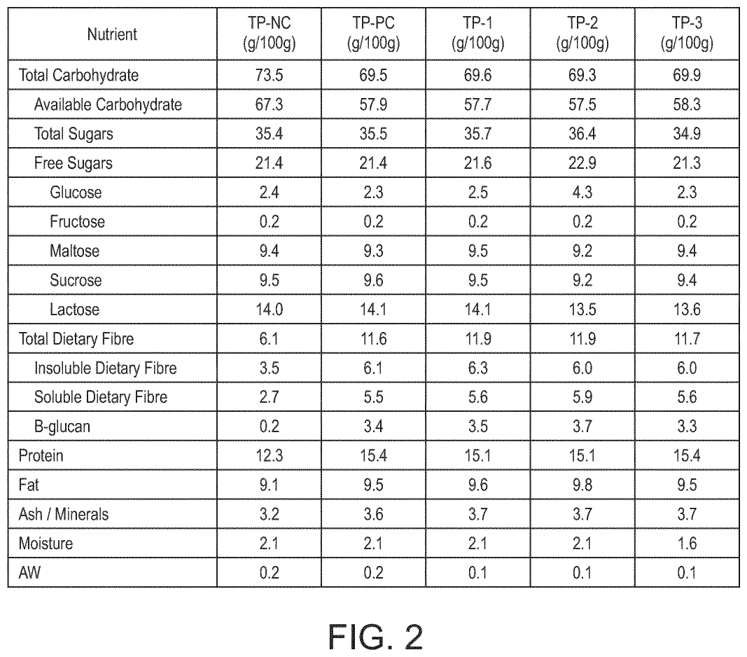

FIGS. 3A-3C are a set of graphs and tables showing the results of β-glucan properties according to certain embodiments of the present invention. FIG. 3A shows the protection of β-glucan MW both in TP-1 and TP-2. FIGS. 3B and 3C show no loss of β-glucan content and increase of β-glucan extractability. TP-NC: CMB with readily-digestible Carbohydrates; TP-PC: CMB with SweOat; TP-1: CMB with oat hydrolyzed with a protease and an α-amylase; TP-2: CMB with oat hydrolysed with a protease and an α-amylase, and an amyloglucosidase; and TP-3: CMB with Extruded Oat.

FIG. 4 is a graph showing the results of beverage viscosity according to certain embodiments of the present invention. Analysis using concentric cylinder probe; and Descending temperature range from 60-25 °C at a shear rate of 75 s⁻¹ to simulate consumer drinking experience. TP-NC: CMB with readily-digestible Carbohydrates; TP-PC: CMB with SweOat; TP-1: CMB with oat hydrolyzed with a protease and an α-amylase; TP-2: CMB with oat hydrolysed with a protease and an α-amylase, and an amyloglucosidase; and TP-3: CMB with Extruded Oat.

FIG. 5 (FIGS. 5A-5C) is a set of graphs showing the results of hedonic liking (n=100) based on flavor (FIG. 5A), texture (FIG. 5B) and overall liking (FIG. 5C) according to certain embodiments of the present invention. Profiling by consumer panel; and scale: 0-9. Significant improvement in liking between SweOat (TP-PC) and hydrolysed oat bran (TP-1 & TP-2) samples. Liking between hydrolysed oat bran (TP-1 & TP-2) samples and negative control (TP-NC) is comparable. TP-NC: CMB with readily-digestible Carbohydrates; TP-PC: CMB with SweOat; TP-1: CMB with oat hydrolyzed with a protease and an α-amylase; TP-2: CMB with oat hydrolysed with a protease and an α-amylase, and an amyloglucosidase; and TP-3: CMB with Extruded Oat.

FIG. 6 (FIG. 6A and FIG. 6B) is a set of graphs showing the results of glycemic and insulin response (n=20) according to certain embodiments of the present invention. Acute, randomised, double-blind, controlled, crossover study. Attenuation of postprandial glycemic response (PGPR; FIG. 10A), without a change in postprandial insulin response (PPIR; FIG. 10B). TP-NC: CMB with readily-digestible Carbohydrates; TP-PC: CMB with SweOat; TP-1: CMB with oat hydrolyzed with a protease and an α-amylase; TP-2: CMB with oat hydrolysed with a protease and an α-amylase, and an amyloglucosidase; and TP-3: CMB with Extruded Oat.

FIG. 7 is a table showing additional analysis with Unigrain Oat bran flour (fine) according to certain embodiments of the present invention.

FIG. 8 is a graph showing the viscosity of hydrolysate according to certain embodiments of the present invention. The hydrolysate includes 0.75 g β-glucan per serving or 0.35 g β-glucan/100 ml. TP-PC: CMB with SweOat; TP-1: CMB with oat hydrolyzed with a protease and an α-amylase; TP-2: CMB with oat hydrolysed with a protease and an α-amylase, and an amyloglucosidase.

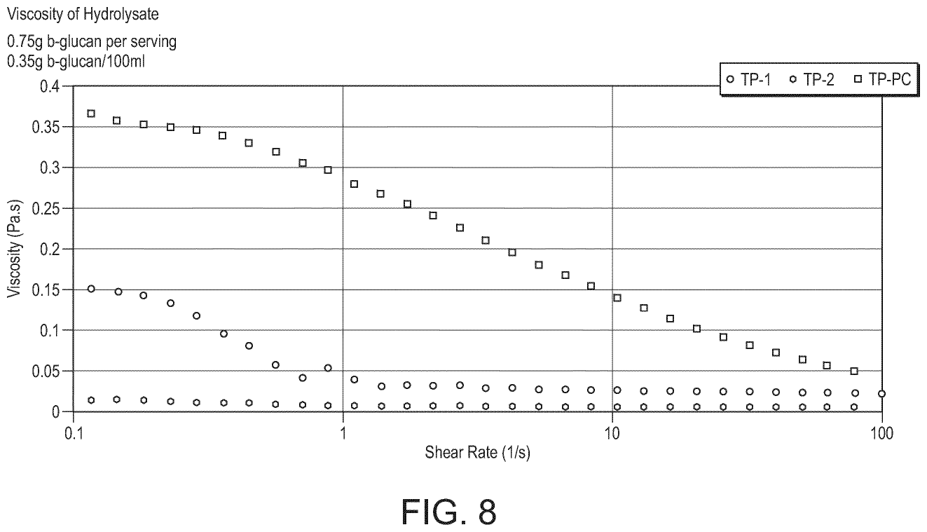

FIG. 9 is a diagram showing a production flow of powdered hydrolyzed oat bran and incorporation into powdered cocoa malt beverage powder according to certain embodiments of the present invention.

FIG. 10 is a diagram showing a production flow for an oat bran milk RTD foodstuff according to certain embodiments of the present invention.

### DETAILED DESCRIPTION

### Definitions

Some definitions are provided hereafter. Nevertheless, definitions may be located in the “Embodiments” section below, and the above header “Definitions” does not mean that such disclosures in the “Embodiments” section are not definitions.

All percentages expressed herein are by weight of the total weight of the composition unless expressed otherwise. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,”“ ” “an” and “the” include plural referents unless the context clearly dictates otherwise. Thus, for example, reference to “a component” or “the component” includes two or more components.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified.

The term “and/or” used in the context of “X and/or Y” should be interpreted as “X,” or “Y,” or “X and Y.” Similarly, “at least one of X or Y” should be interpreted as “X,” or “Y,” or “X and Y.” For example, “at least one a vitamin and/or a mineral” should be interpreted as “a vitamin,” or “a mineral,” or “both vitamin and mineral.”

Where used herein, the terms “example” and “such as,” particularly when followed by a listing of terms, are merely exemplary and illustrative and should not be deemed to be exclusive or comprehensive. As used herein, a condition “associated with” or “linked with” another condition, means the conditions occur concurrently, preferably means that the conditions are caused by the same underlying condition, and most preferably means that one of the identified conditions is caused by the other identified condition.

The term “per serving,” as used herein, preferably refers to the amount of food in a sealed container such as a can or a bottle or a powdered beverage sachet, or the amount per serving based on on-pack declaration. In some embodiments, per serving may refer to the volume of the food in a sealed container such as a can or a bottle. For example, the per serving for the food in a 2 U.S. fluid ounces (U.S. fluid oz) container may be about 60 ml; the per serving for the food in a 4 U.S. fluid oz container may be about 120 ml; the per serving for the food in a 9 U.S. fluid oz container may be about 270 ml; the per serving for the food in a 12 U.S. fluid oz container may be about 355 ml; the per serving for the food in a 16.9 U.S. fluid oz container may be about 500 ml; the per serving for the food in a 20 U.S. fluid oz container may be about 591 ml; the per serving for the food in a 24 U.S. fluid oz container may be about 710 ml; and the per serving for the food in a 33.8 U.S. fluid oz container may be about 1000 ml.

As used herein, an “effective amount,” or “pharmaceutically effective amount,” as used herein, refers to an amount that prevents a deficiency, treats a disease or medical condition in an individual or, more generally, reduces symptoms, manages progression of the diseases or provides a nutritional, physiological, or medical benefit to the individual. The relative terms “promote,” “improve,” “increase,” “enhance” and the like refer to the effects of a composition comprising β-glucan having an average molecular weight of between 400 kDa and 5000 kDa (preferably between 500 kDa and 3000 kDa) to improve sensory properties while maintain the β-glucan MW and health properties, relative to a composition lacking β-glucan with the average molecular weight range lower than 400 kDa or a composition lacking-glucan with the average molecular weight of between 400 kDa and 5000 kDa (preferably between 500 kDa and 3000 kDa), but otherwise identical.

The term “nutritional product,” as used herein, refers to any product that can be used to provide nutrition to a subject. Typically, a nutritional product contains a protein source, a carbohydrate source and a lipid source.

The term “functional food product,” as used herein, refers to a food product providing an additional health-promoting or disease-preventing function to the individual.

The term “healthy ageing product,” as used herein, refers to a product providing an additional health-promoting or disease-preventing function related to healthy ageing to the individual.

The term “beverage product,” as used herein, refers to a nutritional product in liquid form that may be safely consumed by an individual.

The term “pet food product,” as used herein, refers to a nutritional product that is intended for consumption by pets. A pet, or companion animal, as referenced herein, is to be understood as an animal selected from dogs, cats, birds, fish, rodents such as mice, rats.

As used herein, an “effective amount” is an amount that prevents a deficiency, treats a disease or medical condition in an individual or, more generally, reduces symptoms, manages progression of the diseases or provides a nutritional, physiological, or medical benefit to the individual.

All ingredients of the composition can be admixed together or alternatively the composition can be provided in the form of a kit of parts wherein ingredients or groups of ingredients are provided separately. These separate compositions may be intended to be consumed separately or together.

It is understood that according to certain embodiments, the compound of the disclosure or composition thereof may be a nutraceutical composition, pharmaceutical composition, functional food, functional nutrition product, medical food, medical nutrition product, or a dietary supplement.

The terms “nutraceutical” combines the words “nutrition” and “pharmaceutical”. It is a food or food product that provides health and medical benefits, including the prevention and treatment of a condition, disorder, or disease. A nutraceutical is a product isolated or purified from foods that is generally sold in medicinal forms not usually associated with food. A nutraceutical is demonstrated to have a physiological benefit or provide protection against a condition, disorder, or disease. Such products may range from isolated nutrients, dietary supplements and specific diets to genetically engineered foods, herbal products, and processed foods such as cereals, soups, and beverages.

The term “beverages” includes liquid foodstuffs resulting from reconstitution of a powder with an edible diluent such as water or milk. In some embodiments, beverages encompass non-alcoholic and alcoholic drinks as well as liquid preparations to be added to drinking water and liquid food. Non-alcoholic drinks may include, e.g., soft drinks, sports drinks, fruit juices, teas and milk-based drinks. Liquid foods may include, e.g., soups and dairy products.

The term “functional food,” “functional nutrition product,” “medical food,” or “medical nutrition product,” as used herein, refers to any healthy food claimed to have a health-promoting or disease-preventing property beyond the basic function of supplying nutrients. The general category of functional foods includes processed food or foods fortified with health-promoting additives, like “vitamin-enriched” products.

The terms “food,” “food product” and “food composition” or “diet product” mean a product or composition that is intended for ingestion by an individual such as a human and provides at least one nutrient to the individual. The compositions of the present disclosure, including the many embodiments described herein, can comprise, consist of, or consist essentially of the elements disclosed herein, as well as any additional or optional ingredients, components, or elements described herein or otherwise useful in a diet.

The term “ready-to-drink beverage” or “RTD beverage,” as used herein, refers to a beverage that is consumable without addition of any further components, or the like.

The term “prevention” or “preventing,” as used herein, refers to reduction of risk and/or severity of a condition, disorder, or disease.

The term “treatment,” “treating,” “treat,” “attenuate,” or “alleviate,” as used herein, refers to both prophylactic or preventive treatment (that prevent and/or slow the development of a targeted pathologic condition or disorder) and curative, therapeutic or disease-modifying treatment, including therapeutic measures that cure, slow down, lessen symptoms of, and/or halt progression of a diagnosed pathologic condition or disorder, and include treatment of patients at risk of contracting a disease or suspected to have contracted a disease, as well as patients who are ill or have been diagnosed as suffering from a disease or medical condition. The term does not necessarily imply that a subject is treated until total recovery. These terms also refer to the maintenance and/or promotion of health in a subject not suffering from a disease but who may be susceptible to the development of an unhealthy condition. These terms are also intended to include the potentiation or otherwise enhancement of one or more primary prophylactic or therapeutic measure. The terms “treatment,” “treat,” “attenuate” and “alleviate” are further intended to include the dietary management of a disease or condition or the dietary management for prophylaxis or prevention a disease or condition. A treatment can be patient-or doctor-related.

Obesity, which is an excess of body fat relative to lean body mass, is a chronic disease that is highly prevalent in modern society. It is associated not only with a social stigma, but also with decreased life span and numerous medical problems, including adverse psychological development, coronary artery disease, hypertension, stroke, diabetes, hyperlipidemia, and some cancers, (see, e.g., Nishina, et al., Metab. 43:554-558, 1994; Grundy and Barnett, Dis. Mon. 36:641-731, 1990; Rissanen, et al., British Medical Journal, 301:835-837, 1990).

The term “obesity related disorders,” as used herein, refers to those diseases or conditions where excessive body weight or high “body mass index (BMI)” has been implicated in the progression or suppression of the disease or condition. Representative examples of obesity related disorders include, without limitation diabetes, diabetic complications, insulin sensitivity, polycystic ovary disease, hyperglycemia, dyslipidemia, insulin resistance, metabolic syndrome, obesity, body weight gain, inflammatory diseases, diseases of the digestive organs, stenocardia, myocardial infarction, sequelae of stenocardia or myocardial infarction, senile dementia, and cerebrovascular dementia. See, Harrison's Principles of Internal Medicine, 13th Ed., McGraw Hill Companies Inc., New York (1994). Examples, without limitation, of inflammatory conditions include diseases of the digestive organs (such as ulcerative colitis, Crohn's disease, pancreatitis, gastritis, benign tumor of the digestive organs, digestive polyps, hereditary polyposis syndrome, colon cancer, rectal cancer, stomach cancer and ulcerous diseases of the digestive organs), stenocardia, myocardial infarction, sequelae of stenocardia or myocardial infarction, senile dementia, cerebrovascular dementia, immunological diseases and cancer in general.

The term “subject,” “individual,” or “patient,” as used herein, refers to any animal, including a human, that could benefit from one or more of the foodstuff, compositions or methods disclosed herein. Generally, the subject is a human or an avian, bovine, canine, equine, feline, hircine, lupine, murine, ovine or porcine animal. The “companion animal,” as used herein, refers to any domesticated animal, and includes, without limitation, cats, dogs, rabbits, guinea pigs, ferrets, hamsters, mice, gerbils, horses, cows, goats, sheep, donkeys, pigs, and the like. Preferably, the subject is a human or a companion animal such as a dog or cat. The term “elderly” in the context of a human means an age from birth of at least 60 years, preferably above 63 years, more preferably above 65 years, and most preferably above 70 years. The term “older adult” in the context of a human means an age from birth of at least 45 years, preferably above 50 years, more preferably above 55 years, and includes elderly subjects. For other animals, an “older adult” has exceeded 50% of the average lifespan for its particular species and/or breed within a species. An animal is considered “elderly” if it has surpassed 66% of the average expected lifespan, preferably if it has surpassed the 75% of the average expected lifespan, more preferably if it has surpassed 80% of the average expected lifespan. An elderly cat or dog has an age from birth of at least about 7 years.

In some embodiments, the term “subject,” as used herein, refers to a mammal. Mammal includes, but is not limited to, rodents, aquatic mammals, domestic animals such as dogs and cats, farm animals such as sheep, pigs, cows and horses, and humans. In some embodiments, the mammal may be a cat, a dog or a human. The human may be a woman, for example, a woman who is trying to get pregnant, or who is pregnant. In some embodiments of the invention, the subject is a mammal selected from the group consisting of a cat, a dog and, a human. For example, the subject may be an old human.

### Embodiments

### Foodstuff and Compositions

An aspect of the present disclosure is a foodstuff comprising β-glucan having an average molecular weight between 400 kDa and 5000 kDa, preferably between 500 kDa and 3000 kDa.

In some embodiments, the foodstuff is in a liquid form. For example, the foodstuff is any one of a liquid beverage, a soup, or any other liquid food composition or nutritional product. In some embodiments, the foodstuff is selected from the group consisting of a liquid beverage and a soup. Preferably, the foodstuff is a ready-to-drink (RTD) beverage.

In some embodiments, the β-glucan has an average molecular weight between 400 kDa and 5000 kDa, preferably between 500 kDa and 4000 kDa, more preferably between 500 kDa and 3500 kDa, and most preferably between 500 kDa and 3000 kDa.

In some embodiments, the β-glucan has an average molecular weight greater than 400 kDa, preferably greater than 500 kDa, more preferably greater than 530 kDa, even more preferably greater than 600 kDa, further more preferably greater than 700 kDa, even further more preferably greater than 800 kDa, and most preferably greater than 800 kDa.

Applicant surprisingly found that the present foodstuff comprising β-glucan having an average molecular weight (MW) between 400 kDa and 5000 kDa (preferably between 500 kDa and 3000 kDa) both improves sensory properties of the foodstuff and maintains the β-glucan MW and its associated health properties.

In some embodiments, the foodstuff has a reduced viscosity and increased solubility. In some embodiments, the foodstuff has a shear viscosity between 0.0001 Pa·s (pascal second) and 0.3 Pa·s, preferably between 0.005 Pa·s and 0.25 Pa·s, more preferably between 0.003 Pa·s and 0.22 Pa·s, even more preferably between 0.001 Pa·s and 0.2 Pa·s, and most preferably between 0.001 Pa·s and 0.2 Pa·s, when measured at 25 °C at a shear rate of 0.1 s⁻¹, 1 s⁻¹, 10 s⁻¹ or 100 s⁻¹.

In some embodiments, the foodstuff has a shear viscosity less than 0.3 Pa·s, preferably less than 0.25 Pa·s, more preferably less than 0.22 Pa·s, even more preferably less than 0.2 Pa. s, and most preferably less than 0.2 Pa·s, when measured at 25 °C at a shear rate of 0.1 s⁻¹, 1 s⁻¹, 10 s⁻¹ or 100 s⁻¹.

In some embodiments, the foodstuff has a pharmaceutically effective amount of β-glucan with the desired average molecular weight (e.g., between 400 kDa and 5000 kDa, preferably between 500 kDa and 3000 kDa) to reduce viscosity and increase solubility of the foodstuff.

In some embodiments, the foodstuff has β-glucan content of at least 0.5 g per serving, preferably at least 0.55 g per serving, more preferably at least 0.6 g per serving, even more preferably at least 0.65 g per serving, further more preferably at least 0.7 g per serving, most preferably at least 0.75 g per serving.

In some embodiments, the foodstuff has a β-glucan content of any of: between 0.5 g and 1.5 g per serving, between 0.55 g and 1.5 g per serving, between 0.6 g and 1.5 g per serving, between 0.65 g and 1.5 g per serving, between 0.7 g and 1.5 g per serving, or between 0.75 g and 1.5 g per serving,. Preferably, the foodstuff has a β-glucan content of between 0.75 g and 1.5 g per serving.

In some embodiments, the foodstuff has a β-glucan content of any of: at least 0.1 g per 100 ml of the foodstuff or the foodstuff after reconstitution in a diluent (e.g., water), at least 0.15 g per 100 ml of the foodstuff or the foodstuff after reconstitution in a diluent (e.g., water), at least 0.2 g per 100 ml of the foodstuff or the foodstuff after reconstitution in a diluent (e.g., water), at least 0.25 g per 100 ml of the foodstuff or the foodstuff after reconstitution in a diluent (e.g., water), at least 0.3 g per 100 ml of the foodstuff or the foodstuff after reconstitution in a diluent (e.g., water), at least 0.35 g per 100 ml of the foodstuff or the foodstuff after reconstitution in a diluent (e.g., water), or at least 0.4 g per 100 ml of the foodstuff or the foodstuff after reconstitution in a diluent (e.g., water). Preferably, the foodstuff has a β-glucan content of at least 0.35 g per 100 ml of the foodstuff or the foodstuff after reconstitution in a diluent (e.g., water).

In some embodiments, the foodstuff has a β-glucan content of any of: between 0.1 g and 1 g per 100 ml of the foodstuff or the foodstuff reconstituted in a diluent (e.g., water), between 0.1 g and 1.5 g per 100 ml of the foodstuff or the foodstuff after reconstitution in a diluent (e.g., water), between 0.15 g and 1 g per 100 ml of the foodstuff or the foodstuff after reconstitution in a diluent (e.g., water), between 0.15 g and 1.5 g per 100 ml of the foodstuff or the foodstuff after reconstitution in a diluent (e.g., water), between 0.2 g and 1 g per 100 ml of the foodstuff or the foodstuff after reconstitution in a diluent (e.g., water), 0.2 g and 1.5 g per 100 ml of the foodstuff or the foodstuff after reconstitution in a diluent (e.g., water), between 0.25 g and 1 g per 100 ml of the foodstuff or the foodstuff after reconstitution in a diluent (e.g., water), between 0.25 g and 1.5 g per 100 ml of the foodstuff or the foodstuff after reconstitution in a diluent (e.g., water), between 0.3 g and 1 g per 100 ml of the foodstuff or the foodstuff after reconstitution in a diluent (e.g., water), between 0.3 g and 1.5 g per 100 ml of the foodstuff or the foodstuff after reconstitution in a diluent (e.g., water), between 0.35 g and 1 g per 100 ml of the foodstuff or the foodstuff after reconstitution in a diluent (e.g., water), between 0.35 g and 1.5 g per 100 ml of the foodstuff or the foodstuff after reconstitution in a diluent (e.g., water), between 0.4 g and 1 g per 100 ml of the foodstuff or the foodstuff after reconstitution in a diluent (e.g., water), or between 0.4 g and 1.5 g per 100 ml of the foodstuff or the foodstuff after reconstitution in a diluent (e.g., water). Preferably, the foodstuff has a β-glucan content of between 0.35 g and 1.5 g per 100 ml of the food or the foodstuff after reconstitution in a diluent (e.g., water) stuff.

In some embodiments, the foodstuff further comprises one or more of dairy ingredients (e.g. milk), plant-based milks, cereals, oils; emulsifiers; stabilizers; sweeteners; flavors; or minerals.

In some embodiments, the emulsifiers comprise one or more of diacetyl tartaric acid esters of mono-and di-glycerides, lecithin, or mono-and di-glycerides. In a preferred embodiment, the emulsifiers comprise lecithin.

In some embodiments, the stabilizers comprise one or more of microcrystalline cellulose (MCC), carboxymethyl cellulose (CMC), gellan (e.g., a high acyl gellan), a modified starch (e.g., a physically modified and/or chemically modified starch), pectin, alginate, guar, xanthan or the like. In a preferred embodiment, the stabilizers comprise gellan (e.g., a high acyl gellan).

In some embodiments, the sweeteners comprise one or more of sugars (e.g., monosaccharides such as glucose, fructose, and galactose; and disaccharides such as sucrose, lactose, and maltose), dextrose, maltodextrin, saccharin and its various salts such as a sodium salt; dipeptide sweeteners such as aspartame; dihydrochalcone compounds, glycyrrhizin; Stevia Rebaudiana (Stevioside); chloro derivatives of sucrose such as sucralose; and sugar alcohols such as sorbitol, mannitol, sylitol, or the like. In a preferred embodiment, the sugars comprise sucrose.

In some embodiments, the flavors comprise one or more cocoa powder, fruit or fruit juices or juice concentrate or fruit juice powder, or ginger.

In some embodiments, the minerals comprise one or more salts of calcium (e.g., CaCO₃), phosphorous, iodine, iron, magnesium, copper, zinc, manganese, chlorine, potassium, sodium, selenium, chromium, or molybdenum. In a preferred embodiment, the minerals comprise calcium (e.g., CaCO₃).

In some embodiments, the foodstuff consists of the β-glucan and a diluent such as water, dairy ingredients (e.g. milk), or plant-based milks and optionally at least one of cereals, oils; emulsifiers; stabilizers; sweeteners; flavors; or minerals. In some embodiments, the foodstuff consists essentially of the β-glucan and a diluent such as water, dairy ingredients (e.g. milk), or plant-based milks and optionally at least one of cereals, oils; emulsifiers; stabilizers; sweeteners; flavors; or minerals.

In some embodiments, the foodstuff comprises a hydrolysate from an oat-based material comprising at least one of oat, barley, or rye, and the hydrolysate comprises at least a portion of the β-glucans. In some embodiments, at least some of the β-glucans of the present disclosure were from a hydrolysate from an oat-based material comprising at least one of oat, barley, or rye. In some embodiments, at least some of the β-glucans of the present disclosure were from a hydrolysate from an oat-based material comprising either oat or barley. In other embodiments, at least some of the β-glucans of the present disclosure were from a hydrolysate from an oat (e.g., oat bran).

In some embodiments, all the β-glucans of the present disclosure were from a hydrolysate from an oat-based material comprising at least one of oat, barley, or rye. In some embodiments, all the β-glucans of the present disclosure were from a hydrolysate from an oat-based material comprising either oat or barley. In some embodiments, all the β-glucans of the present disclosure were from a hydrolysate from an oat (e.g., oat bran).

Applicant surprisingly found that an enzyme composition can improve the sensory properties of liquid applications with β-glucans by reducing viscosity and increasing solubility through the targeted hydrolysis of starches and proteins, but with minimal β-glucanase activity in an oat-based material such as oat bran.

In some embodiments, the hydrolysate comprises starches in an amount of any of 0 to 20% by dry weight, 0 to 15% by dry weight, 0 to 10% by dry weight, 0 to 9% by dry weight, 0 to 8% by dry weight, 0 to 7% by dry weight, 0 to 6% by dry weight, 0 to 5% by dry weight, 0 to 4% by dry weight, 0 to 3% by dry weight, 0 to 2% by dry weight, or 0 to 5% by dry weight of initial starches in the oat-based material. Preferably, the hydrolysate comprises starches in an amount of 0 to 10% by dry weight of initial starches in the oat-based material.

In some embodiments, the hydrolysate comprises β-glucan in an amount of any of 70% to 100% by dry weight, 75% to 100% by dry weight, 80% to 100% by dry weight, 85% to 100% by dry weight, 90% to 100% by dry weight, or 95% to 100% by dry weight of initial β-glucan in the oat-based material. Preferably, the hydrolysate comprises β-glucan in an amount of 80% to 100% by weight of initial β-glucan in the oat-based material.

In some embodiments, the hydrolysate comprises:
starches in an amount of any of 0 to 20% by dry weight, 0 to 15% by dry weight, 0 to 10% by dry weight, 0 to 9% by dry weight, 0 to 8% by dry weight, 0 to 7% by dry weight, 0 to 6% by dry weight, 0 to 5% by dry weight, 0 to 4% by dry weight, 0 to 3% by dry weight, 0 to 2% by dry weight, 0 to 5% by dry weight (preferably 0 to 10% by weight) of initial starches in the oat-based material; and
β-glucan in an amount of any of 70% to 100% by dry weight, 75% to 100% by dry weight, 80% to 100% by dry weight, 85% to 100% by dry weight, 90% to 100% by dry weight, or 95% to 100% by dry weight (preferably 80% to 100% by weight) of initial β-glucan in the oat-based material.

In some embodiments, the hydrolysate is produced by a process comprising subjecting the oat-based material to an enzyme composition comprising an α-amylase and optionally a protease. In some embodiments, the enzyme composition comprises both an α-amylase and a protease. In some embodiments, the enzyme composition consists of an α-amylase and a protease. In some embodiments, the enzyme composition consists essentially of an α-amylase and a protease.

In some embodiments, the hydrolysate comprises at least one of the protease or the α-amylase. In some embodiments, the hydrolysate comprises both the protease and the α-amylase.

In some embodiments, the enzyme composition comprises an α-amylase, optionally a protease and optionally an amyloglucosidase. In some embodiments, the enzyme composition comprises an α-amylase, a protease and an amyloglucosidase. In some embodiments, the enzyme composition consists of an α-amylase, optionally a protease and optionally an amyloglucosidase. In some embodiments, the enzyme composition consists essentially of an α-amylase, optionally a protease and optionally an amyloglucosidase.

In some embodiments, the hydrolysate comprises at least one of the protease, the α-amylase or the amyloglucosidase. In some embodiments, the hydrolysate comprises at least two of the protease, the α-amylase or the amyloglucosidase. In some embodiments, the hydrolysate comprises all the protease, the α-amylase and the amyloglucosidase. In some embodiments, the hydrolysate consists essentially of all the protease, the α-amylase and the amyloglucosidase.

### Process of Hydrolysis and Process of Modulating a Carbohydrates:Fiber:Sugar Ratio

In another aspect, the present disclosure relates to a process of hydrolyzing an oat-based material comprising at least one of oat, barley, or rye with an enzyme composition to produce the β-glucans having an average molecular weight (MW) between 400 kDa and 5000 kDa (preferably between 500 kDa and 3000 kDa).

In some embodiments, a process of hydrolyzing an oat-based material (e.g., oat bran) with an enzyme composition comprising an α-amylase and optionally a protease, the process comprising: hydrolyzing the oat bran with the α-amylase to form a first mixture; and optionally hydrolyzing the oat bran in the first mixture with the protease to form a second product.

In some embodiments, a process of hydrolyzing an oat-based material (e.g., oat bran) with an enzyme composition comprising an α-amylase and optionally a protease, the process comprising: hydrolyzing the oat bran with the protease to form a first mixture; and optionally hydrolyzing the oat bran in the first mixture with the α-amylase to form a second product.

In some embodiments, a process of hydrolyzing an oat-based material (e.g., oat bran) with an enzyme composition comprising an α-amylase, optionally an amyloglucosidase and optionally a protease, the process comprising one or more of the following:
hydrolyzing the oat bran with the α-amylase to form a first mixture; and hydrolyzing the oat bran in the first mixture with the amyloglucosidase to form a second product;
hydrolyzing the oat bran with a mixture of the α-amylase and the protease to form a first mixture; and hydrolyzing the oat bran in the first mixture with the amyloglucosidase to form a second product;
hydrolyzing the oat bran with the α-amylase to form a first mixture; hydrolyzing the oat bran in the first mixture with the protease to form a second product; and hydrolyzing the oat bran in the second product with the amyloglucosidase to form a third product; and
hydrolyzing the oat bran with the protease to form a first mixture; hydrolyzing the oat bran in the first mixture with the α-amylase to form a second product; and hydrolyzing the oat bran in the second product with the amyloglucosidase to form a third product.

In some embodiments, a process of hydrolyzing an oat-based material (e.g., oat bran) with an enzyme composition comprising an α-amylase, optionally an amyloglucosidase and optionally a protease, the process comprising: hydrolyzing the oat bran with a mixture of the α-amylase and the protease to form a product.

In some embodiments, the process further comprises a step of pasteurizing the product from the hydrolysis.

In some embodiments, the pasteurizing step is conducted at a temperature range of about 70 °C-about 200 °C, preferably about 75 °C-about 180 °C, more preferably about 70 °C-about 160 °C, most preferably about 80 °C-about 150 °C, for about 2 seconds-about 2 hours, preferably about 2 seconds-about 1.5 hours, more preferably about 3 seconds-about 1.5 hours, even more preferably about 4 seconds-about 1.5 hours, and most preferably about 5 seconds-about 1 hour.

In some embodiments, the process further comprises a step of drying the product from the hydrolysis.

In some embodiments, the drying step is conducted at a temperature range of about 30 °C-about 140 °C, preferably about 35 °C-about 130 °C, more preferably about 40 °C-about 120 °C, even more preferably about 45 °C-about 110 °C,, and most preferably about 50 °C-about 100 °C for about 0.1 hours-about 20 hours, preferably about 0.3 hours-about 18 hours, more preferably about 0.5 hours-about 17 hours, even more preferably about 0.7 hours about 16 hours, and most preferably about 0.9 hours-about 15 hours

In some embodiments, the enzyme composition consists of the protease and the α-amylase.

In some embodiments, the process further comprises hydrolyzing the oat bran with an amyloglucosidase. The step of hydrolyzing the oat bran with an amyloglucosidase can be included anywhere in the process. For example, the oat bran can be hydrolyzed by the α-amylase, the protease, and the amyloglucosidase in any sequence.

In some embodiments, the oat bran can be hydrolyzed by a mixture of the α-amylase, the protease, and the amyloglucosidase.

In some embodiments, the enzyme composition consists of the protease, the α-amylase and the amyloglucosidase.

In some embodiments, the amount of the enzyme composition in the hydrolysis is any of less than 5% by weight, less than 4.5% by weight, less than 4% by weight, less than 3.5% by weight, less than 3% by weight, less than 2.5% by weight, less than 2.4% by weight, less than 2.3% by weight, less than 2.2% by weight, or less than 2.1% by weight of the oat-based material. Preferably, the amount of the enzyme composition in the hydrolysis is less than 2% by weight of the oat-based material.

In some embodiments, the amount of the enzyme composition in the hydrolysis is any of 0.001 to 5% by weight, 0.002 to 4.5% by weight, 0.003 to 4% by weight, 0.004 to 3.5% by weight, 0.005 to 3% by weight, 0.006 to 2.5% by weight, 0.007 to 2.4% by weight, 0.008 to 2.3% by weight, 0.009 to 2.2% by weight, or 0.0095 to 2.1% by weight of the oat-based material. Preferably, the amount of the enzyme composition in the hydrolysis is 0.001% to 2% by weight of the oat-based material.

In some embodiments, the process is conducted at a temperature range of 4 °C-95 °C, preferably 2 °C-95 °C, more preferably 3 °C-95 °C, even more preferably 4 °C-95 °C, and most preferably 50 °C-80 °C and for 1 minutes-10 hours, preferably 5 minutes-8 hours, more preferably 10 minutes-6 hours, even more preferably 15 minutes-5 hours, and most preferably 15 minutes-4 hours.

Applicant surprisingly found that in the present process, an enzyme composition (e.g., an enzyme cocktail) employed at specific hydrolysis conditions is capable of controlled hydrolysis of an oat-based material (e.g., oat bran) to maximize breakdown of starches but minimize hydrolysis of β-glucans. This allows the improvement of product texture and taste, whilst maintaining its β-glucan MW and health properties.

The Examples provide an example of the process for controlled hydrolysis of an oat-based material (e.g., oat bran).

In another aspect, the present disclosure relates to a process of modulating a carbohydrates: fiber: sugar ratio.

In some embodiments, the process comprises subjecting the oat-based material (e.g., oat bran) to an enzyme composition comprising an α-amylase and optionally a protease to form a hydrolysate suitable for a product selected from the group consisting of a liquid beverage and a soup.

In some embodiments, the process comprises subjecting the oat-based material (e.g., oat bran) to an enzyme composition consisting of (consisting essentially of) an α-amylase, optionally a protease and optionally an amyloglucosidase to form a hydrolysate suitable for a product selected from the group consisting of a liquid beverage and a soup.

In some embodiments, the enzyme composition further comprises an amyloglucosidase.

### Methods

Another aspect of the present disclosure is a method for improving metabolic health (e.g., treating, preventing or mitigating a condition, disorder, or disease intake of one or more of carbohydrates, fibres or sugars) by using the foodstuff or composition comprising the β-glucans as disclosed herein. In some embodiments, the method comprises administering a subject in need thereof the foodstuff or composition comprising the β-glucans as disclosed in the present invention.

In some embodiments, the method is to treat, prevent or mitigate a health issue linked to intake of one or more of carbohydrates, fibres or sugars, by attenuating postprandial glycemic response (PGPR) without causing a change in postprandial insulin in a subject in need thereof. In some embodiments, the method comprises administering a subject in need thereof the foodstuff or composition comprising the β-glucans as disclosed in the present invention.

In some embodiments, the method is to improve metabolic health comprising treating, preventing or mitigating a metabolic disorder. In some embodiments, the metabolic disorder comprises obesity, type 2 diabetes, cardiovascular disease. In some embodiments, the metabolic disorder is selected from the group consisting of obesity, type 2 diabetes, and cardiovascular disease.

In some embodiments, the method is to prevent or mitigate a health issue linked to intake of one or more of carbohydrates, fibres or sugars, by reducing levels of total and low-density lipoproteins (LDL) cholesterol, boosting fiber intake, improving blood sugar regulation, promoting digestive health and regularity, and/or supporting weight management in a subject in need thereof.

In some embodiments, the method for improving metabolic health comprises treating, preventing or mitigating an obesity related disorder. In some embodiments, the obesity related disorder comprises diabetic complications, insulin sensitivity, polycystic ovary disease, hyperglycemia, dyslipidemia, insulin resistance, metabolic syndrome, obesity, body weight gain, inflammatory diseases, diseases of the digestive organs, stenocardia, myocardial infarction, sequelae of stenocardia or myocardial infarction, senile dementia, and cerebrovascular dementia. In some embodiments, the obesity related disorder is selected from the group consisting of diabetic complications, insulin sensitivity, polycystic ovary disease, hyperglycemia, dyslipidemia, insulin resistance, metabolic syndrome, obesity, body weight gain, inflammatory diseases, diseases of the digestive organs, stenocardia, myocardial infarction, sequelae of stenocardia or myocardial infarction, senile dementia, and cerebrovascular dementia.

In some embodiments, the present disclosure is a method of treating or preventing a condition selected from the group consisting of obesity, type 2 diabetes, cardiovascular disease, diabetic complications, insulin sensitivity, polycystic ovary disease, hyperglycemia, dyslipidemia, insulin resistance, metabolic syndrome, obesity, body weight gain, inflammatory diseases, diseases of the digestive organs, stenocardia, myocardial infarction, sequelae of stenocardia or myocardial infarction, senile dementia, and cerebrovascular dementia.

In some embodiments, the present disclosure is a method of treating or preventing a condition, disorder, or disease related to type 2 diabetes, non-alcoholic fatty liver disease and/or obesity in a subject. As disclosed above, the method comprises administering a subject in need thereof the foodstuff and composition comprising the β-glucans as disclosed in the present invention.

In some embodiments, the foodstuff of the present disclosure and the related composition can lead to at least 0.1%, 0.2%, 0.3%, 0.4%, 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80% decrease on cholesterol level in the subject as compared with the control subjects who were not administered with the foodstuff of the present disclosure and the related composition.

In some embodiments, the decrease on cholesterol level by the foodstuff of the present disclosure and the related composition can be sustained up to 3 months, 4 months, 5 months, 6 months, 7 months, 8 months, 9 months, 10 months, 11 months, 12 months, 13 months, 14 months, 15 months, 16 months, 17 months, 18 months, 19 months, 20 months, 21 months, 22 months, 23 months, 24 months, 36 months, or 48 months.

In yet another aspect, the present disclosure relates to a method of treatment or prevention of a condition, disorder, or disease related to cardiovascular, weight management, type 2 diabetes, and/or obesity comprising administration of the foodstuff or composition comprising the β-glucans as disclosed herein.

In some embodiments, the condition may be a metabolic disorder such as obesity, type 2 diabetes, cardiovascular disease or an obesity related disorder such as diabetic complications, insulin sensitivity, polycystic ovary disease, hyperglycemia, dyslipidemia, insulin resistance, metabolic syndrome, obesity, body weight gain, inflammatory diseases, diseases of the digestive organs, stenocardia, myocardial infarction, sequelae of stenocardia or myocardial infarction, senile dementia, and cerebrovascular dementia.

The foodstuff or composition may be administered by any method appreciated by the skilled artisan. For example, the foodstuff or composition of the disclosure is preferably administered by oral administration. In some embodiments, the foodstuff or composition of the disclosure may be administered by intravenous administration, topical administration, parenteral administration, intraperitoneal administration, intramuscular administration, intrathecal administration, intralesional administration, intracranial administration, intranasal administration, intraocular administration, intracardiac administration, intravitreal administration, intraosseous administration, intracerebral administration, intraarterial administration, intraarticular administration, intradermal administration, transdermal administration, transmucosal administration, sublingual administration, enteral administration, sublabial administration, insufflation administration, suppository administration, inhaled administration, or subcutaneous administration.

In some embodiments, the foodstuff or composition of the present disclosure may have an acute effect that can be seen in less than one month. Additionally or alternatively, the foodstuff or composition of the present disclosure can have a long-term effect, and thus various embodiments comprise administration of the composition to the individual (e.g., orally) for a time period of at least one month; preferably at least two months, more preferably at least three, four, five or six months; and most preferably for at least one year. During the time period, the composition can be administered to the individual at least one day per week; preferably at least two days per week, more preferably at least three, four, five or six days per week; and most preferably seven days per week. The foodstuff or composition can be administered in a single dose per day or in multiple separate doses per day. In some embodiments, a single dose for β-glucans is any of at least 0.5 g/serving, at least 0.55 g/serving, at least 0.6 g/serving, at least 0.65 g/serving, at least 0.7 g/serving, or at least 0.75 g/serving. Preferably, a single dose for-glucans is at least 0.75 g/serving. In some embodiments, a single dose for β-glucans is at least 0.15 g/100 ml, preferably at least 0.2 g/100 ml, more preferably at least 0.25 g/100 ml, even more preferably at least 0.3 g/100 ml, and most preferably at least 0.35 g/100 ml. In some embodiments, a single dose for β-glucans is at least 1 g/100 g, preferably at least 1.5 g/100 g, more preferably at least 2 g/100 g, and most preferably at least 2.5 g/100 g.

In further embodiment, the invention relates to a liquid foodstuff for use in A method to preventing or mitigating a health issue linked to intake of one or more of carbohydrates, fibers or sugars in a subject in need thereof, by attenuating postprandial glycemic response (PGPR) without causing a change in postprandial insulin response in said subject in need thereof, the method comprising administering to the subject the wherein the liquid foodstuff is a foodstuff according to of any of Claims 1-10.

In an additional embodiment of the invention relates to a liquid foodstuff for use in A method to preventing or mitigating a health issue linked to intake of one or more of carbohydrates, fibers or sugars in a subject in need thereof, by reducing levels of total and low-density lipoproteins (LDL) cholesterol, boosting fiber intake, improving blood sugar regulation, promoting digestive health and regularity, and/or supporting weight management in a said subject in need thereof, the method comprising administering to the subject wherein the liquid foodstuff is a foodstuff according to of any of Claims 1-10.

### Examples

Cocoa Malt Beverage (CMB) Powder was used as the product samples. It includes 12% by weight variable ingredients such as TP-NC (Low DE maltodextrin); TP-PC (22% B-glucan oat bran DSM “OatWell® 22XF”or SweOat® “BG22 XF”) ; TP1 (Enzymatic hydrolysis with a protease and an α-amylase; TP2-Enzymatic hydrolysis with a protease), an α-amylase, and an amyloglucosidase; and TP3 (Extruded oat bran). Generally, 50 g CMB Powder was added into 330 ml of water at 80 °C.

The research questions include differences between negative control (TP-NC) and β-glucan containing beverages; and differences in glycemic response between positive control (TP-PC) and beverages containing additionally processed oats. Relevant analyses include-glucan content; β-glucan molecular weight; β-glucan extractability; postprandial glycemic response (clinical trial) and Sensory evaluation (hedonic liking). Other analyses include full nutrient composition analysis; product viscosity; in-vitro digestion viscosity; and other clinical markers (insulin response, gut hormones, gastric emptying rate, satiety, gastrointestinal comfort).

### Enzymatic Treatment Conditions

TP-1: CMB base powder (75-95%) with oat hydrolysed with a protease & an α-amylase (5%-25%).
Substrate: SweOat® 22XF/OatWell® 22XF
Processing Conditions:
a protease—1 minute-10 hours; 4 °C-95 °C
an α-amylase—1 minute-10 hours; 4 °C-95 °C
Pasteurisation—1 minute-10 hours; 80 °C-95 °C
Drying
1 minute-20 hours; 10 °C-110 °C
TP-2: CMB base powder (75-95%) with oat hydrolysed with a protease, an α-amylase, an amyloglucosidase (5-25%).
Substrate: SweOat® 22XF/OatWell® 22XF
Processing Conditions:
a protease—1 minute-10 hours; 4 °C-95 °C
an α-amylase—1 minute-10 hours; 4 °C-95°C
an amyloglucosidase—1 minute-10 hours; 4 °C-95 °C
Pasteurisation—1 minute-10 hours; 80 °C-95 °C
Drying
1 minute-20 hours; 10 °C-110 °C

### Example 1. Enzyme Cocktail Controlled Hydrolysis of Oat Bran (OatWell®)

The current disclosure is an enzyme cocktail employed at specific hydrolysis conditions for the controlled hydrolysis of oat bran to maximize breakdown of starches but minimize hydrolysis of β-glucans. This allows the improvement of product texture and taste, whilst maintaining its β-glucan MW and health properties. TP-1 is made with OatWell® (oat bran) hydrolysed with an enzyme cocktail consisting of a protease and an α-amylase. Upon hydration of the oat bran at 1%-30% total solids at 4 °C-95 °C, oat bran was hydrolyzed with the protease for 1 minute-2 hours at 4 °C-95 °C before the addition of the amylase at 4 °C-95 °C for 1 minute-2 hours. TP-2 was made via the same starting steps as TP-1, followed by the addition of an additional enzyme, amyloglucosidase at 4 °C-95 °C for 1 minute-2 hours.

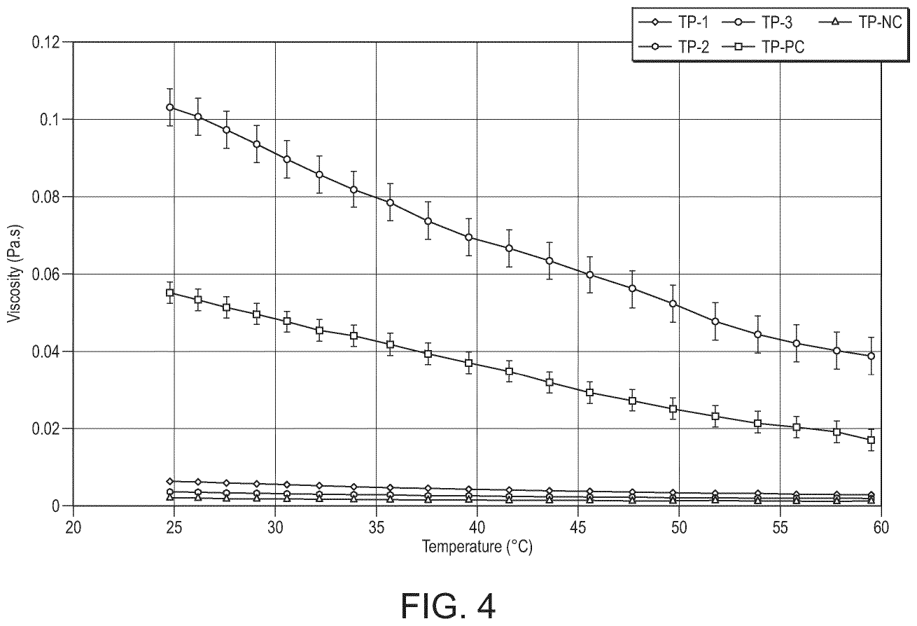

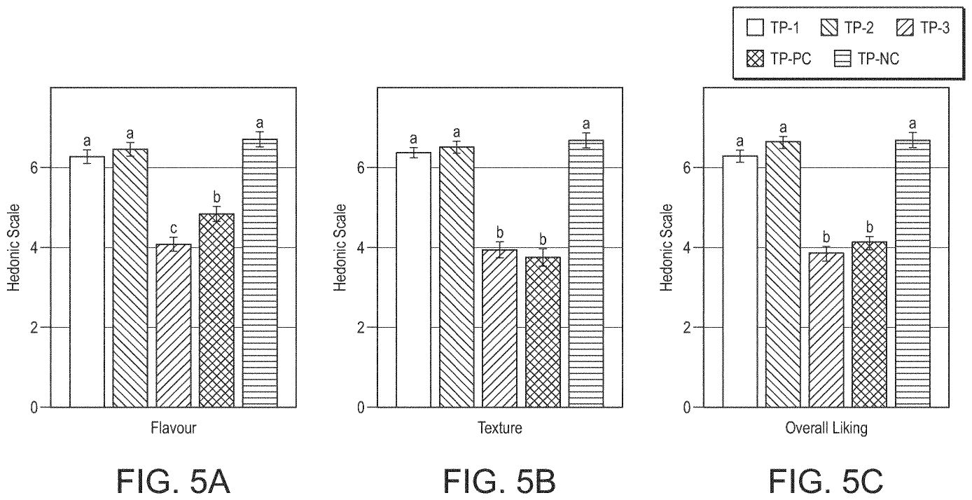

The enzyme cocktail hydrolyzes proteins, starches and maltooligosaccharides respectively, improving product solubility and reducing product viscosity (body) in the process (FIG. 4). The lower viscosity is responsible for the greater overall liking and liking in texture of TP-1 and TP-2 from the TP-PC (unprocessed OatWell®-containing beverage) (FIG. 5 (FIGS. 5A-5C)).

### Example 2. Enzyme Cocktail Controlled Hydrolysis of Oat Bran (Oat Bran Flour From Unigrain)

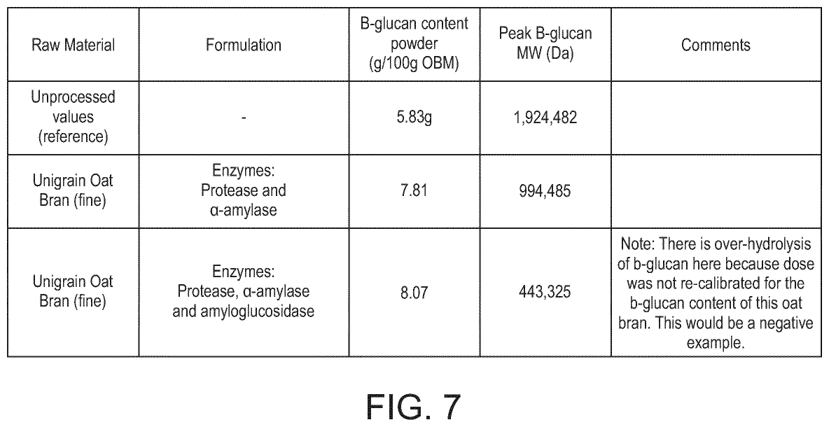

An additional experiment was also run with a different oat bran, oat bran flour from Unigrain, to verify that the results could be achieved in a different oat bran (FIG. 7). When applying the same enzymes at the same dose and hydrolysis conditions, β-glucan MW was reduced to 994 kDa and 443 kDa for the enzyme cocktail used with TP-1 and TP-2 respectively. This shows that the enzyme dose needs to be moderated for different oat brans, but the β-glucan MW can still be maintained at a reasonable high level with other oat bran flours.

### Example 3

β-glucans, present in various cereals like oat and barley, have a protective effect against cardiovascular diseases. This is attributed by their ability to attenuate glycemic response and lower cholesterol, amongst other benefits (Comprehensive Reviews in Food Science and Food Safety, 11(4), 355-365, 2012). EFSA permits glycemic response claims for products containing 4 g of-glucan per 30 g available carbohydrate content per serving and cholesterol lowering claims for products containing 1 g of β-glucan per serving (ID 851, 852. EFSA Journal, 9(6), 2011; Nutrition Research Reviews, 30(2), 149-190, 2017).

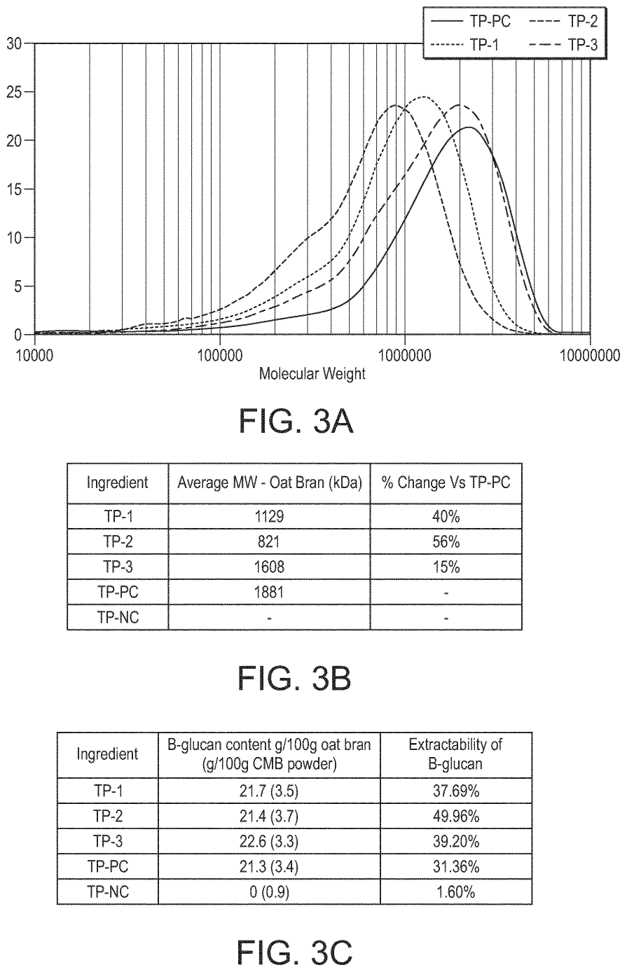

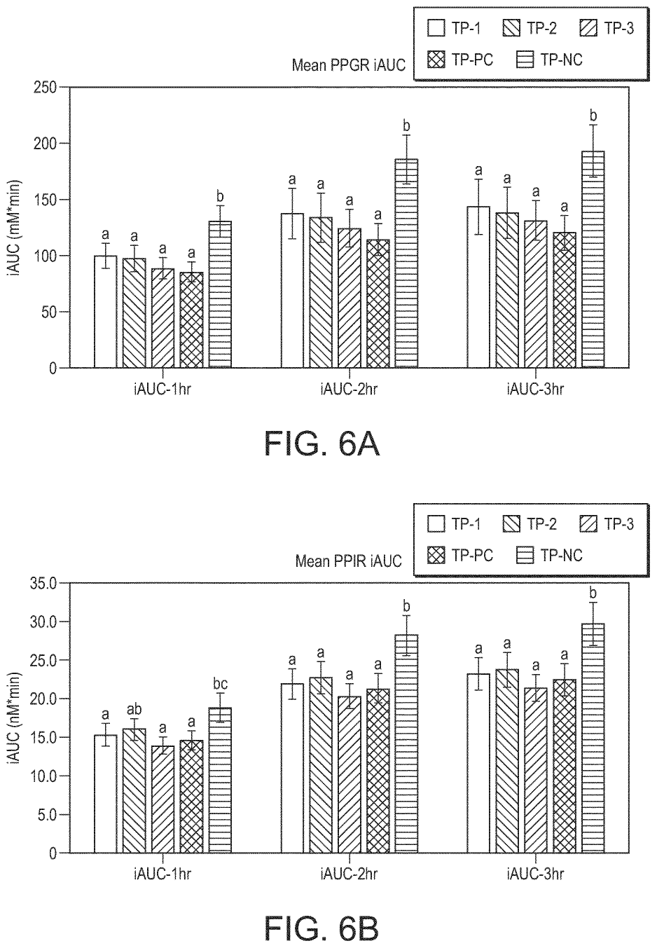

The cholesterol-lowering and glycemic management properties of β-glucan is a function of its concentration, MW and extractability. OatWell has been shown to reduce cholesterol when consumed at a β-glucan dose recommended by EFSA (The FASEB Journal, 24(S1), 336.335-336.335, 2010a). Wolever et al. (The American Journal of Clinical Nutrition, 92(4), 723-732, 2010b) showed that a β-glucan MW of >530 kDa can lower blood cholesterol levels. Controlled hydrolysis with both enzyme cocktails ensured the final β-glucan MW was well within this 530 kDa limit (FIGS. 3A-3C). This is possible because both Alcalase 2.4 L and MATS L Classic have been shown to have minimal β-glucanase activity (internal note: Vafeiadi et al., 2014; Wavreille et al., 2011). Both enzyme cocktails also increased β-glucan extractability relative to OatWell oat bran (FIGS. 3A-3C), increasing the amount of available-glucan for interaction with gastrointestinal contents (Nutrients, 11(8), 2019). OatWell has also been shown to attenuate postprandial glycemic response, though not at a dose as low as what has been used in the current study (Nutrients, 8(9), 2016). An attenuation of postprandial glycemic response in this clinical study showed that a β-glucan dose of 1.76 g per 30 g available carbohydrate in a 330 ml serving is sufficient to achieve this effect. Treatment with both enzyme cocktails did not have a significant effect on glycemic response relative to TP-PC, indicating that it is just as effective in glucose management after hydrolysis (FIGS. 6A and 6B). This is possible from the control of enzymatic treatment aimed at increasing β-glucan extractability, but minimizing β-glucanase activity.

### Example 4

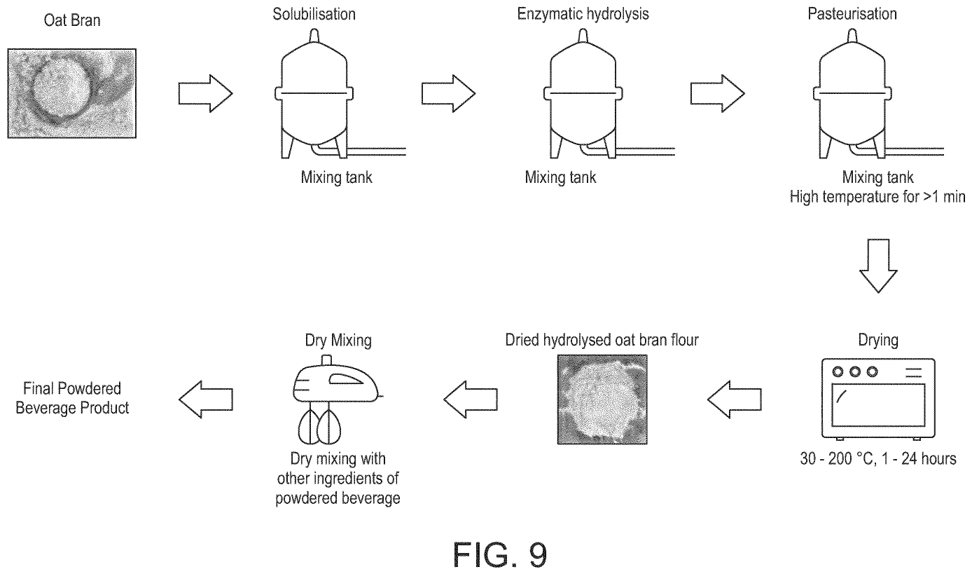

FIG. 9 shows an example of a process for producing a liquid foodstuff. As shown in FIG. 9, a process for producing a liquid foodstuff comprising: providing oat bran (e.g., OatWell® 22 XF); performing solubilisation of the oat bran, for example in a mixing tank; performing enzymatic hydrolysis of the solubilized oat bran, for example in a mixing tank, preferably using one or more the enzyme compositions disclosed herein; pasteurizing the hydrolysate, for example in the same or different mixing tank at a high temperature for at least 1 minute; drying the pasteurized hydrolysate, for example in a vacuum oven at 30-200 °C for 1-24 hours; dry mixing the dried hydrolysate with other ingredients, for example one or more of cocoa powder, malt extract, skimmed milk powder, sucrose, minerals, or water; and reconstituting the mixture into a liquid foodstuff.

### Example 5

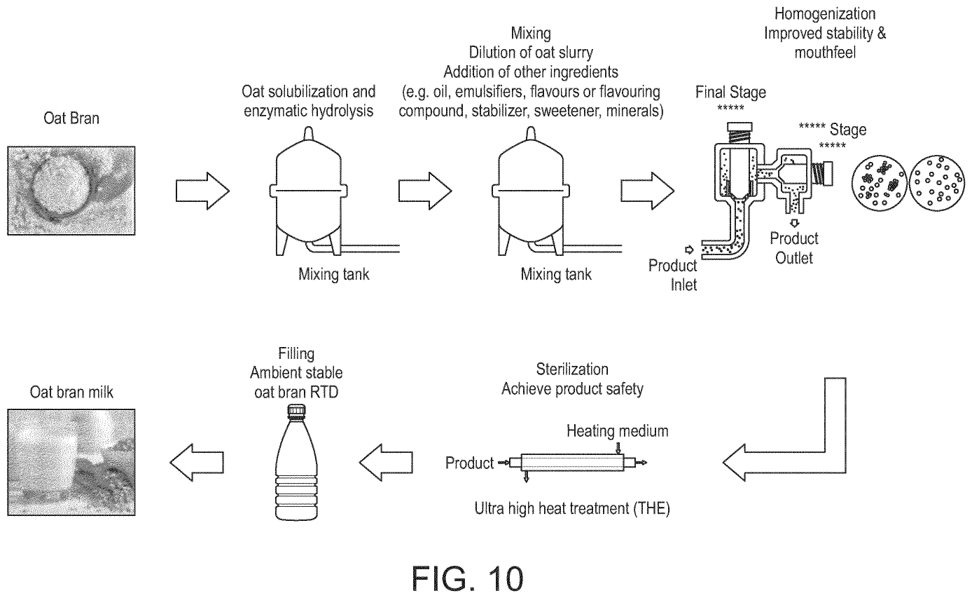

FIG. 10 shows an example of a process for producing a liquid foodstuff (e.g., an oat bran milk RTD foodstuff). As shown in FIG. 10, a process for producing an oat bran milk RTD foodstuff comprising: providing oat bran (e.g., OatWell® 22 XF); performing solubilisation of the oat bran and enzymatic hydrolysis (preferably using one or more the enzyme compositions disclosed herein) of the solubilized oat bran and pasteurizing the hydrolysate, for example in a mixing tank; mixing a dilution of oat slurry with other ingredients, e.g., oil; emulsifiers; stabilizer, sweeteners, flavors; and/or minerals, for example in the same or different tanks; performing a homogenization of the resulting mixture to improve stability and mouthfeel, for example in a homogenization device; performing sterilization of the homogenized product to achieve product safety, for example using a ultrahigh heat treatment; filing the sterilized product and a liquid (e.g., water or milk) into a container to form an ambient stable oat bran RTD foodstuff (e.g., forming an oat bran milk).

1. A liquid foodstuff comprising β-glucans having an average molecular weight between 400 kDa and 5000 kDa, and the liquid foodstuff having a shear viscosity between 0.0001 Pa·s (pascal second) and 0.3 Pa·s, when measured at 25 °C at a shear rate of 0.1 s⁻¹, 1 s⁻¹, 10 s⁻¹ and 100 s⁻¹, wherein the liquid foodstuff has a β-glucan content of:
at least 0.5 g of the β-glucans per serving of the liquid foodstuff; and/or
between 0.1 g and 1.5 g of the β-glucans per 100 ml of the liquid foodstuff.

2. The liquid foodstuff of claim 1, wherein the liquid foodstuff further comprises one or more of dairy ingredients, plant-based milks, cereals, oils, emulsifiers, stabilizers, sweeteners, flavors, or minerals.

3. The liquid foodstuff of claim 1, wherein the liquid foodstuff is selected from the group consisting of a liquid beverage and a soup.

4. The liquid foodstuff of claim 1, wherein the liquid foodstuff comprises a hydrolysate from an oat-based material comprising at least one of oat, barley, or rye, and the hydrolysate comprises at least a portion of the β-glucans.

5. The liquid foodstuff of claim 4, wherein the oat-based material comprises oat bran.

6. The liquid foodstuff of claim 4, wherein the hydrolysate comprises:
starches in an amount of 0 to 20% by dry weight of initial starches in the oat-based material; and
β-glucan in an amount of 70% to 100% by dry weight of initial β-glucan in the oat-based material.

7. The liquid foodstuff of claim 4, wherein the hydrolysate is produced by a process comprising subjecting the oat-based material to an enzyme composition comprising an α-amylase, optionally a protease, and optionally an amyloglucosidase.

8. The liquid foodstuff of claim 7, wherein the amount of the enzyme composition in the process is 0.001 to 5% by weight of the oat-based material.

9. The liquid foodstuff of claim 7, wherein the enzyme composition consists of the α-amylase, optionally the protease, and optionally the amyloglucosidase.

10. The liquid foodstuff of claim 7, wherein the process is conducted at a temperature range of 4 °C-95 °C, and for 1 minutes-10 hours.

11. A liquid foodstuff for use in preventing or mitigating a health issue linked to intake of one or more of carbohydrates, fibers or sugars in a subject in need thereof, by attenuating postprandial glycemic response (PGPR) without causing a change in postprandial insulin response in said subject, wherein the liquid foodstuff comprises β-glucans having an average molecular weight between 400 kDa and 5000 kDa, and the liquid foodstuff has a shear viscosity between 0.0001 Pa·s (pascal second) and 0.3 Pa·s when measured at 25 °C at a shear rate of 0.1 s⁻¹, 1 s⁻¹, 10 s⁻¹ and 100 s⁻¹, wherein the liquid foodstuff has a β-glucan content of:
at least 0.5 g of the β-glucans per serving of the liquid foodstuff; and/or
between 0.1 g and 1.5 g of the-glucans per 100 ml of the liquid foodstuff.

12. (canceled)

13. A process of modulating a carbohydrates: fiber: sugar ratio of an oat-based material, the process comprising subjecting the oat-based material to an enzyme composition comprising an α-amylase, optionally a protease, and optionally an amyloglucosidase to form a hydrolysate suitable for a product selected from the group consisting of a liquid beverage and a soup.

14. The liquid foodstuff of claim 1, wherein the average molecular weight of the β-glucans is between 500 kDa and 3000 kDa.

15. The liquid foodstuff of claim 1, wherein the shear viscosity of the liquid foodstuff is between 0.001 Pa·s and 0.2 Pa·s, when measured at 25 °C at a shear rate of 0.1 s⁻¹, 1 s⁻¹, 10 s⁻¹ and 100 s⁻¹.

16. The liquid foodstuff of claim 1, wherein the liquid foodstuff is a ready-to-drink (RTD) beverage.

17. The liquid foodstuff of claim 4, wherein the hydrolysate comprises:
starches in an amount of 0 to 10% by dry weight of initial starches in the oat-based material; and
β-glucan in an amount of 80% to 100% by dry weight of initial β-glucan in the oat-based material.

18. The liquid foodstuff of claim 7, wherein the process is conducted at a temperature range of 50 °C-80 °C for 15 minutes-4 hours.

19. The liquid foodstuff of claim 7, wherein the amount of the enzyme composition in the process is 0.001% to 2% by weight of the oat-based material.
